(19) United States
(12) Patent Application Publication
(10) Pub. No.: US 2016/0363260 A1
(43) Pub. Date: Dec. 15, 2016

(54) Rotary auger tie downs

(71) Applicant: Kevin Brooks, Leitchfield, KY (US)

(72) Inventor: Kevin Brooks, Leitchfield, KY (US)

(21) Appl. No.: 14/999,090

(22) Filed: Mar. 29, 2016

Related U.S. Application Data
(63) Continuation-in-part of application No. 14/998,681, filed on Feb. 5, 2016.
Application No. 14/998,681 is a continuation-in-part of application No. 14/121,468, filed on Sep. 9, 2014, now Pat. No. 9,347,733.
Application No. 14/121,468 is a continuation of application No. 14/121,469, filed on Sep. 9, 2014, now Pat. No. 9,316,016.
Application No. 14/121,469 is a continuation of application No. 13/998,981, filed on Dec. 30, 2013, now abandoned.
Application No. 13/998,981 is a continuation-in-part of application No. 29/474,232, filed on Jul. 16, 2014, now Pat. No. D752414.

(51) Int. Cl. F16M 13/02

(52) U.S. Cl. CPC F16M 13/02

(57) ABSTRACT

A rotary auger tie down mounting stand for removably holding a tie down upright on the ground. The stand includes an elongated rod with a helical coil or flights forming an auger base having a point at the lower distal end to be fixedly and removably screwed into the ground to support the stand in an upright position. The top distal end of the rod forming the stand body defines a holding means such as a loop, ring, or hook extending above an main body handle portion comprising a S-shaped loop forming a handle and having a holding means such as a loop or hook extending from a top distal end of the elongated rod which provides an anchor for a rope, chain, strap or other tether to support a structure attached thereto. The integral loop handle provides a means for rotating the auger into the ground.

### CROSS REFERENCE TO RELATED APPLICATIONS

This application claims priority and is a continuation-in-part of U.S. application Ser. No. 14/998,681 filed on Feb. 5, 2016 which claims priority and is a continuation-in-part of U.S. application Ser. No. 14/121,468 filed on Sep. 9, 2014 which claims priority and is a continuation-in-part of application Ser. No. 13/998,981 filed on Dec. 30, 2013, and claims priority and is a continuation-in-part of U.S. Design Application Ser. No. 29/474,232 filed on Jul. 16, 2014 all of which are incorporated herein in its entirety.

### TECHNICAL FIELD

The present invention relates to a rotary stake stand for supporting a tie down in an upright position in the ground.

### BACKGROUND OF THE INVENTION

The portable and reusable auger tie down holder of the present invention includes means for attachment comprising a hook, loop, or curved tie down member for cooperatively engaging a rope, string, strap, chain, tent flap, or other holding member such as volley ball net, soccer net, tent rope, decoy support, camera support, landscape lighting, guide or support cables from other vertical support members and the like. The auger tie down includes an integrated S-shaped loop handle for rotatably embedding a helical auger into the ground with no tools by twisting and rotating the handle screwing the auger base into the ground providing a tie down support.

### SUMMARY OF THE INVENTION

A rotary auger tie down for removably holding a object securely in a desired location or position. The tie down includes an upright rod with a helical coil or flights of an elongated rod comprising round, square, or rectangular bar stock forming an auger having a point at the lower distal end to be fixedly and removably screwed into the ground to support the stand in an upright position. The top end of the rod forming the stand body defines an S-shaped loop configured, sized and shaped and disposed at a selected angle to support a holding or tie down member. The integral tie down member extends from the top distal end of the elongated rod.

The portable and reusable auger of the present invention can be used in combination with an integrated loop handle which can be installed in the ground with no tools by twisting and rotating the handle screwing the auger base into the ground.

It is an object of this invention to provide a portable and reusable tie down holder stand which includes a helical coil at one end which can be screwed into the ground.

It is an object of this invention to provide a tie down support stand which includes an integral crank handle for the purpose of screwing the stand into the ground.

It is an object of this invention to provide an integral crank handle for the purpose of screwing the stand into the ground wherein the crank handle services to support the arm of a tie down substantially vertically with respect to the ground.

It is another object of the present invention to provide a tie down holder wherein the integral handle serves to rotate the tie down.

It is another object of the present invention to provide a integrated handle with a friction enhancing sleeve composed of a fabric, polymer, rubber, or elastomer to cover a selected portion of the tie down rest.

The present invention is for a rotary auger tie down stand comprising or consisting of an elongated vertical rod having a helical spiral coil extending downward therefrom a selected distance for penetration into the ground, and at least one “S” shaped loop extending from a top portion of said rod comprising at least two looped sections spaced apart from and in vertical alignment with one another for receiving an arm of a tie down.

More particularly, the rotary auger tie down has a medial portion comprising an elongated rod and a bottom portion comprising a helical spiral coil having a point extending downward from the elongated rod for a selected distance for penetration into the ground. The top portion defines a bow arm rest support comprising at least one curved “S” shaped loop portion extending upwardly from a top distal end of the elongated rod, the “S” shaped loop portion including a first straight section extending outwardly from the elongated rod at a selected angle from the top distal end of the elongated rod. A first curved end section extends from a distal end of the first straight section returning 180 degrees extending inwardly toward the elongated rod forming a second straight section spaced apart, parallel, and in alignment with the first straight section extending past the elongated rod. A second opposing curved end section returns 180 degrees extending inwardly forming a third straight section extending from the second opposing curved end section spaced apart, parallel, and in alignment with the first straight section and the second straight section.

A rotary auger for supporting or mounting and removably holding a articles or devices upright on the ground. The auger includes an upright rod with a helical helix coil having a point at the lower distal end to be fixedly and removably screwed into the ground to support the in an upright position. Thus, a looped handle may be formed integrally within the upper end of the shaft or rod extending from the auger with an vertically disposed “S” shaped loop formed in the center of the for enabling the screwing of the cork screw into the ground for vertical stabilization of the stake.

The auger vertical shaft forms a cork screw or a helical coil formed in the bottom end. The bottom helical coil ends with a round pointed tip if fashioned from cylindrical bar stock or a sharp wedge if fashioned out of square or rectangular bar stock for easing the installation into the ground.

The preferred embodiment of the helical auger includes a helix which is a curve in three dimensional space having a tangent line and any point which makes a constant angle with a fixed line called the axis. The pitch of a helix is the width of one complete helix turn, measured parallel to the axis of the helix. A circular helix has a constant radius and constant band curvature and constant torsion.

A preferred embodiment of the present invention comprises a helical auger including an inner bend diameter of a selected size such as ¼ inch bar stock, 3/16 inch bar stock, ½ inch bar stock, ⅝ inch bar stock , and ⅜ inch bar stock; a helical pitch of 2.0 for 3.5 revolutions; a variable pitch of 3.0 for 0.25 revolutions; and a pitch diameter of 1.375 inches having a helical pitch of 2.0.

Thus in order to obtain a specif 30 degree angle at the bottom of the screw, the helical pitch as to vary from a constant 2 inches per revolution to 3 inches per revolution from section 2 to section 3. Thus the auger has a helical pitch of 2.0 at section 1 for 3.5 revolutions; a helical pitch at section 2 of 2.0 which changes to a variable pitch of 3.0 at section 3 for 0.25 revolutions. The pitch diameter is 1.375 inches.

It is an object of the present invention to form an integral one piece auger having a helical helix formed of stock having a rectangular cross-section.

It is an object of the present invention to form an integral one piece auger having a helical helix formed of stock having a rectangular cross-section forming a ribbon.

A preferred embodiment of the auger portion of the invention comprises or consists of a rotary auger support comprising or consisting of a selected length of bar stock having a square cross sectional area including a bottom portion bent into a helix, a vertical straight top portion, a neck portion extending downward from the vertical straight top portion, a main body portion extending downwardly from the neck portion, the main body portion comprising a helical helix coil extending downward therefrom a selected distance, a distal end segment comprising a half helix extending downward from the main body portion, and the distal end segment including a point for penetration into the ground.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the views wherein:

FIG. 1 is a perspective view of a rotary auger helix having a straight top portion and a main body portion comprising a helix formed of stock having a square cross-section having a distal point cut creating a wedge shaped tip;

FIG. 2 is a rear perspective view of the rotary auger support shown in FIG. 1;

FIG. 3 is a left perspective rear view of a rotary auger support having a rectangular, or square cross section showing the straight top portion defining a tubular adapter extending from the top for cooperative engagement with a corresponding tube or bar stock shaft of an article to be supported thereon;

FIG. 4 is a left perspective rear view of a rotary auger support having a rectangular, or square cross section showing the straight top portion defining a tubular adapter extending from the top for cooperative engagement with a corresponding tube or bar stock shaft of an article to be supported thereon;

FIG. 5 is a top end view of the rotary auger support shown in FIG. 1;

FIG. 6 is a bottom end view of the rotary auger support of FIG. 1;

FIG. 7 is a perspective view showing the angle of the twists forming the flights of the helix stock surface and the angle of the wedge shaped tip;

FIG. 8 is a perspective view showing the proportions of the top distal portion, neck, main body portion and the tip segment;

FIG. 9 is a perspective view showing the angle of the twists forming the flights of the helix stock surface and round pointed tip;

FIG. 10 is a perspective view of a tie down formed from a elongated cylindrical rod having an lower helical auger extending downward from a S-shaped loop handle with a vertical top portion extending above the medial handle portion having a distal end forming a hook;

FIG. 11 is a front plan view of FIG. 10;

FIG. 12 is a rear plan view of FIG. 10;

FIG. 13 is a left side view of FIG. 10;

FIG. 14 is a right side view of FIG. 10;

FIG. 15 is a bottom plan view of FIG. 10;

FIG. 16 is a top plan view of FIG. 10;

FIG. 17 is a left side view of the tie down of FIG. 10 showing a closed loop;

FIG. 18 is a perspective view of the tie down of FIG. 17;

FIG. 19 is a rear plan view of a tie down featuring a closed loop and extended shaft above the loop handle;

FIG. 20 is a perspective view of a tie down having an extended shaft above the helical auger and a loop handle disposed near the top of the elongated extended shaft having a closed loop extended from the distal end thereof;

FIG. 21 is a left side view of the tie down of FIG. 20;

FIG. 22 is a perspective view of a tie down formed from square stock showing a helical auger and a S-shaped loop handle wherein the loop also provides an attachment point or holding means for securing a line or tether thereto; and

FIG. 23 is a perspective view of a tie down formed from cylindrical stock or rod showing a helical auger and a S-shaped loop handle wherein the loop also provides an attachment point or holding means for securing a line or tether thereto.

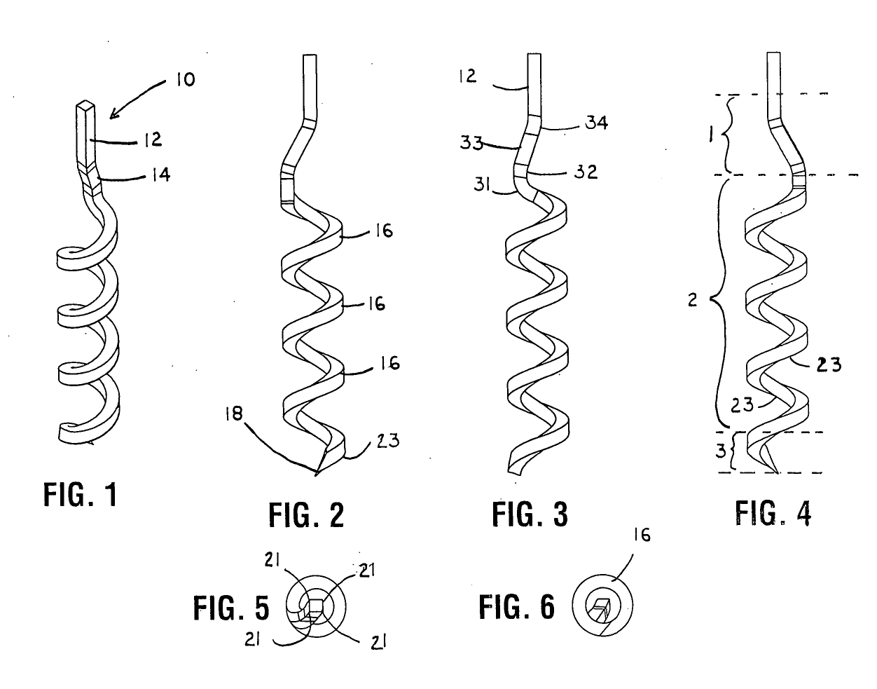

### DESCRIPTION OF THE PREFERRED EMBODIMENTS

A rotary auger support stand for mounting and removably holding a articles or devices upright on the ground. The stand includes an upright rod with a helical coil or flights forming an auger base having a point at the lower distal end to be fixedly and removably screwed into the ground to support the stand in an upright position with a means of attachment to provide an anchor for a rope, cord, or other tether to aid is support of an article or structure in a vertical position.

In accordance with the present invention, there is provided a rotary auger tie down stand 10 which holds a tie down in position above the ground for the intended user. The integral handle tie down rest is located at an upper end of a shaft or elongated vertical rod extending upwardly from an “S-shaped loop handle main body disposed above the auger.

The rotary auger tie down mounting stand 10 provides a portable outdoor rest for removably holding a tie down upright on the ground. The stand includes an above ground upright rod or shaft 12 having a bottom portion for insertion into the ground comprising a helical coil 16 or plurality of flights forming an auger 14 having a point 18 at the lower distal end to be fixedly and removably screwed into the ground to support the stand 10 in an upright position. The middle section of the elongated rod 12 forming the main body defines an S-shaped loop handle 22.

The rotary auger support 10 includes an above ground upright rod or shaft top portion 12 having an offset neck 14 connecting to a main body portion 2 comprising a plurality of helixes 16. A distal end segment 3 comprises a half helix ending in a sharp point 18. A main body portion helixes 16 is comprised of bar stock having a square cross sectional area. The corners 21 or the square bar stock form cutting edges 23 when the stock is bent or formed into a helix. One preferred embodiment of the instant invention includes a main body portion 2 having three full helixes and a tip portion 3 comprising a half helix. The neck 14 of the rotary auger support 10 is angled inwardly toward the center of the main body portion 2 in order to center the shaft top portion 12 with respect to the main body portion 2. As best shown in FIG. 3, the neck portion includes a helix first segment 31, a short straight inward angled second segment 32, a straight angled third segment 33, a short straight outward angled fourth segment 34, connecting to a vertical straight top segment 12 of a desired length.

The rotary auger 10 having a bottom portion for insertion into the ground comprises a helical coil 16 having a cutting edge 23 which functions as a plurality of flights forming an auger 10 having cutting edges 23 with a wedge point 18 at the lower distal end to be fixedly and removably screwed into the ground 20 to support the 10 in an upright position.

The cutting edges 23 of the helix or helical coil 16 enable the auger to cut through soil and debris for ease of rotation and deep ground penetration which includes the desirable features of helix flights. Moreover, the auger of the present invention is an improvement over the flights of conventional augers in that the narrow diameter of the stock and diameter of the flights enables the auger to cut and drill through small openings in rocky soil and wedge between rocks. Moreover, the rotary auger support 10 of the present invention can be rotatably inserted into hard clay which would resist penetration by an auger having flights or a helix auger comprising round stock.

A preferred embodiment of the helical auger includes a top vertical portion for mounting an adapter or article to be supported thereon, a neck, a main body portion and a tip portion including a distal end forming a wedge or pointed segment. An inner bend diameter of a selected size such as ¼ inch bar stock, 3/16 inch bar stock, ½ inch bar stock, ⅝ inch bar stock , and ⅜ inch bar stock. The ⅜ inch rotary auger support includes an effective helical pitch of 2 for every 3.5 revolutions and a variable pitch of 3.0 for every 0.25 revolutions. The pitch diameter of 1.375 inches has a helical pitch of 2.0 inches. As best illustrated in FIG. 6 the angle of the twists forming the flights of the helix of the main body portion are angled forming a plane at 30 degrees shown as angle “A” , however, the range could extend from 15 to 45 degrees.

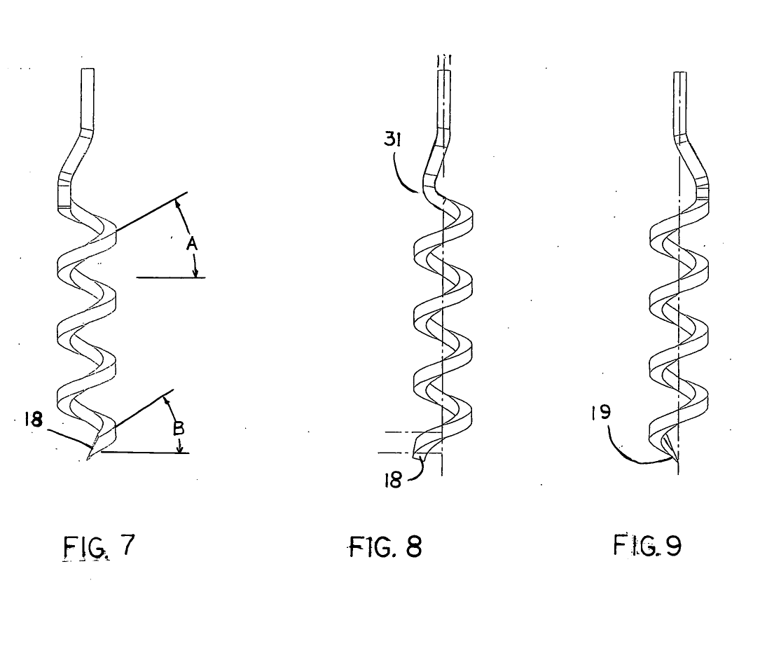

As shown in FIGS. 7-8, the square bar stock is ⅜ inch in width and the distal end of the tip forming a penetrating or cutting edge is cut at a 33 degree angle, Angle “B”, forming an angled wedge of ⅝ inch in length forming a tip comprising a cutting wedge point 18 for easy insertion into rocky ground and grounds containing roots. It is contemplated that the angle of the wedge could range from 15 to 45 degrees depending upon the application. As shown in FIG. 8, the top section 1 is about 4 inches in length, the main body portion 2 comprises four helixes totaling seven inches in length, and the bottom section 3 is about 0.625 inches in length. A round or pointed tip 19 may also be utilized for particular types of substrates such as clay soil as shown in FIG. 9.

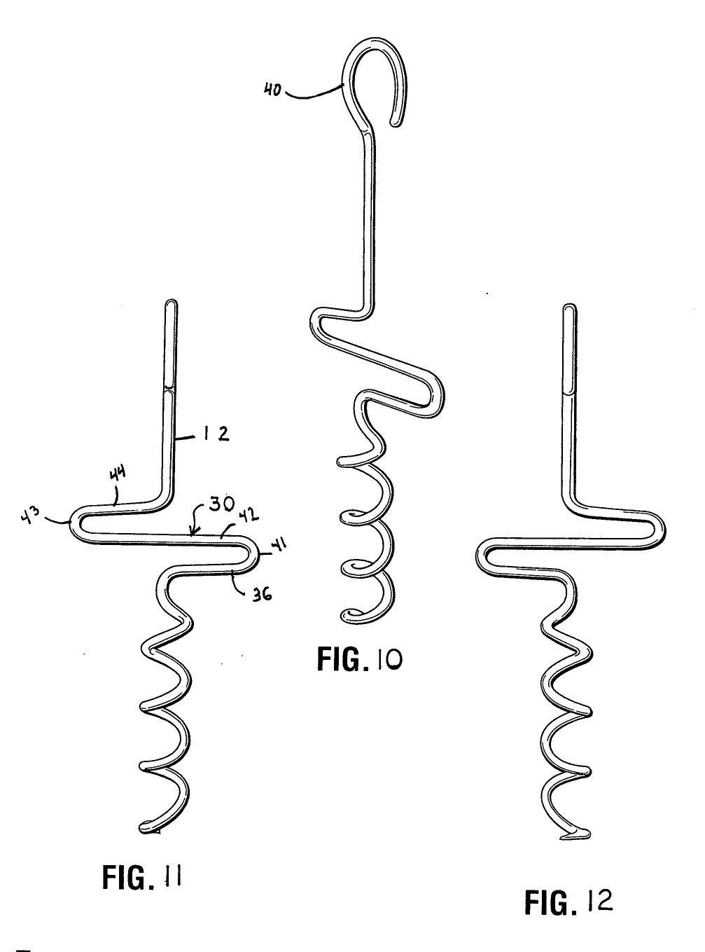

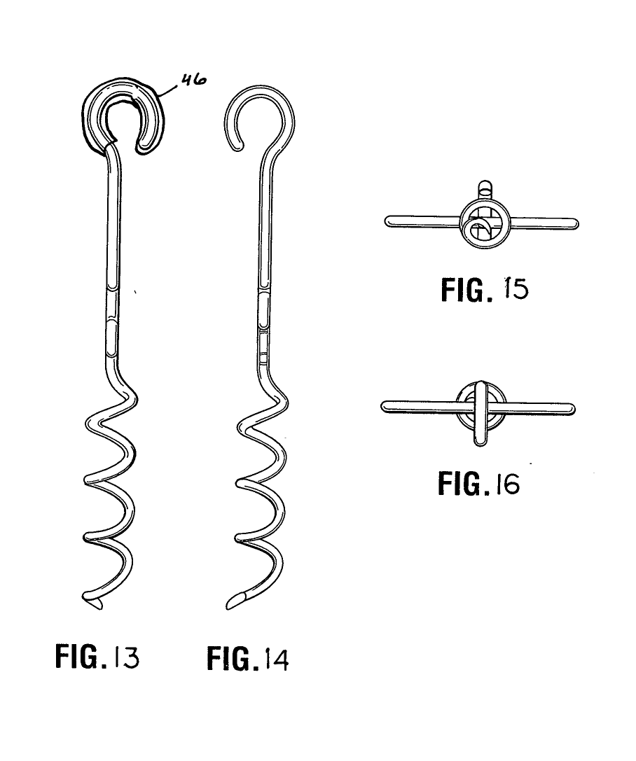

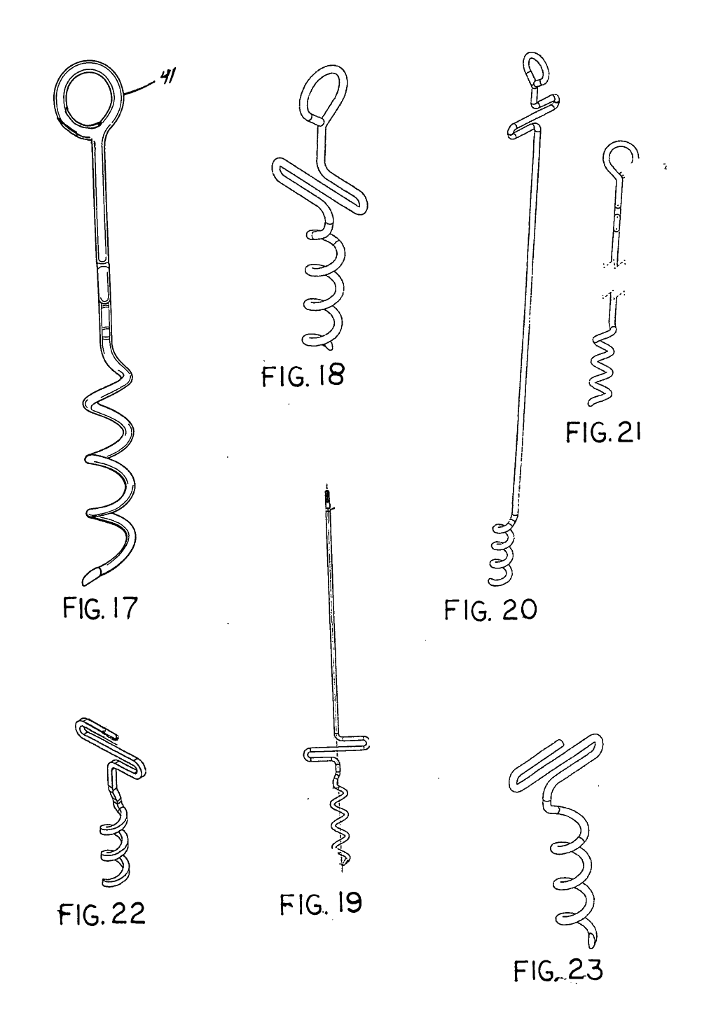

As shown in FIGS. 10-23, a “S-shaped” loop handle 30 may be integrally formed in a portion of the shaft of the auger extending above the ground. The handle top portion comprises at least one curved “S” shaped loop portion extending upwardly from a top distal end of the elongated rod, the “S” shaped loop portion including a first straight section extending outwardly from the elongated rod at a selected angle from the top distal end of the elongated rod. A first curved end section extends from a distal end of the first straight section returning 180 degrees extending inwardly toward the elongated rod forming a second straight section spaced apart, parallel, and in alignment with the first straight section extending past the elongated rod. A second opposing curved end section returns 180 degrees extending inwardly forming a third straight section extending from the second opposing curved end section spaced apart, parallel, and in alignment with the first straight section and the second straight section. A means such as a hook 40 or loop 41 for securing a tether line of strip of material to the top distal end of the top portion of the elongated shaft extending upward from the handle 30 may include a coupling or other mounting means for holding an supporting a selected article above the auger which anchors the support stand in the ground.

The integral crank handle 30 forms a S-shaped loop. The handle 30 includes a first portion 36 which extends outwardly from the rod 12 at a selected angle which is shown as a right angle or 90 degree angle. A second portion 42 extends upwardly over, spaced apart from and in alignment with the first portion forming a curved or bent portion 41 and extends past the shaft 12 a selected equal distance from the shaft 12. A third top portion 44 extends upwardly over, spaced apart from and in alignment with the second portion forming a curved or bent portion 43 and extends to the shaft 12.

A sound dampening sleeve 46 composed of a fabric, polymer, rubber, or elastomer to cover a selected portion of the tie down handle 30. Moreover, the sleeve may be comprised of a plurality of bands such as rubber bands, tape, tube, hose or combinations thereof which to enhance the frictional engagement of the tie down arm against the other material by reducing slippage.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplification presented herein above. Rather, what is intended to be covered is within the spirit and scope of the appended claims.

I claim:

1. A rotary auger support comprising:
a selected length of bar stock having a square cross sectional area including a bottom portion bent into a helix comprising:
a vertical straight top portion;
a neck portion extending downward from said vertical straight top portion;
a main body portion extending downwardly from said neck portion, said main body portion comprising a helical helix coil extending downward therefrom a selected distance;
a distal end segment comprising a half helix extending downward from said main body portion; and
said distal end segment including a point for penetration into the ground.

2. The rotary auger support of claim 1, wherein said main body portion comprises a helical pitch of 2 for every 3.5 revolutions and a variable pitch of 3.0 for every 0.25 revolutions.

3. The rotary auger support of claim 1, wherein said main body portion comprises a pitch diameter of 1.375 inches and a helical pitch of 2.0 inches.

4. The rotary auger support of claim 1, wherein said main body portion comprising a square bar stock defines a cutting edge at each corner of said square bar stock.

5. The rotary auger support of claim 1, said vertical straight top portion including a handle extending above said auger, said handle comprising a curved rod having at least one “S” shaped loop extending upwardly from a top distal end of said medial section comprising a rod having at least two opposing looped sections spaced apart from and in alignment with one another, said at least two opposing looped sections including a first portion extending outwardly from said medial section at a right angle and a second portion extending upwardly over and spaced apart from and in alignment with said first portion forming a first curved loop extending past medial section a selected equal distance from said medial section and a third top portion extending upwardly over and spaced apart from and in alignment with said second portion forming a second curved portion extending a selected distance in alignment with said medial section.

6. The rotary auger support of claim 5, including a mounting means extending from a distal end of said vertical straight top portion.

7. The rotary auger support of claim 6, wherein said mounting means extending from a distal end of said vertical straight top portion comprises a coupling.

8. The rotary auger support of claim 1, including a mounting means extending from a distal end of said vertical straight top portion.

9. The rotary auger support of claim 8, wherein said mounting means extending from a distal end of said vertical straight top portion comprises a coupling.

10. A rotary auger support consisting of:
a selected length of bar stock having a square cross sectional area including a bottom portion bent into a helix comprising:
a vertical straight top portion;
a neck portion extending downward from said vertical straight top portion;
a main body portion extending downwardly from said neck portion, said main body portion comprising a helical helix coil extending downward therefrom a selected distance;
a distal end segment comprising a half helix extending downward from said main body portion; and
said distal end segment including a point for penetration into the ground.

11. The rotary auger support of claim 10, wherein said main body portion comprises a helical pitch of 2 for every 3.5 revolutions and a variable pitch of 3.0 for every 0.25 revolutions.

12. The rotary auger support of claim 10, wherein said main body portion comprises a pitch diameter of 1.375 inches and a helical pitch of 2.0 inches.

13. The rotary auger support of claim 10, wherein said main body portion comprising a square bar stock defines a cutting edge at each corner of said square bar stock.

14. A rotary auger bow stand comprising:
a top distal end section comprising a hook or loop;
a medial section comprising an elongated vertical rod;
a handle comprising a curved rod having at least one “S” shaped loop extending upwardly from a top distal end of said medial section comprising a rod having at least two opposing looped sections spaced apart from and in alignment with one another, said at least two opposing looped sections including a first portion extending outwardly from said medial section at a right angle and a second portion extending upwardly over and spaced apart from and in alignment with said first portion forming a first curved loop extending past medial section a selected equal distance from said medial section and a third top portion extending upwardly over and spaced apart from and in alignment with said second portion forming a second curved portion extending a selected distance in alignment with said medial section; and
a bottom portion of a selected length of bar stock having a square cross sectional area including a bottom portion bent into a helix comprising a neck portion extending downward from said vertical straight top portion, a main body portion extending downwardly from said neck portion, said main body portion comprising a helical helix coil extending downward therefrom a selected distance, a distal end segment comprising a half helix extending downward from said main body portion.
